(19) United States
(12) Patent Application Publication
(10) Pub. No.: US 2009/0015417 A1
(43) Pub. Date: Jan. 15, 2009

(54) Method and apparatus for managing battery log information and method of generating revenue through sales thereof

(75) Inventors: Marc R. Bernard, Miramar, FL (US); Douglas A. Atkinson, Ashburn, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: TELLABS VIENNA, INC., NAPERVILLE, IL (US)

(21) Appl. No.: 11/879,040

(22) Filed: Jul. 13, 2007

(51) Int. Cl. G08B 21/00

(52) U.S. Cl. 340/636.1

(57) ABSTRACT

Example embodiments of the present invention provide management and reporting tools for service providers to manage batteries within battery backup units (BBUs) deployed their networks. Service providers may generate battery reports periodically, on-demand, or on an event driven basis, and, in turn, may notify customers of a status of battery replacement. Specifically, example embodiments of the present invention allow an Optical Network Terminal (ONT) to log BBU history via a craft port, Optical Line Terminal (OLT), direct internal communications with the battery, or some other technician interface. The ONT may store this information in memory when it detects a battery replacement or when a technician issues commands about battery log information. The OLT or an Element Management System (EMS) may query battery log information from all ONTs and generate management reports therefrom. The information may be sold, on a subscription fee basis, for example, to battery manufacturers or service providers.

### BACKGROUND OF THE INVENTION

Some network nodes, such as Optical Network Terminals (ONTs), are equipped with batteries or battery backup units to support continued service in an event of a primary power interruption. As well known, batteries have limited service and shelf life, so when batteries expire, customers are urged to perform maintenance by returning, recycling or disposing of them and installing a new battery or battery backup unit. The manufacturer(s) of the network device, battery or battery backup unit are generally not burdened with maintenance after field deployment, but the maintenance impacts the customer, such as a service provider and, of course, the end users (e.g., subscribers) of the customers. Moreover, as network nodes are upgraded and replaced in the field, new network nodes may not support specific batteries previously deployed from different manufacturers.

### SUMMARY OF THE INVENTION

An embodiment of the present invention is a method and corresponding apparatus for monitoring a battery backup unit. Memory stores baseline information about the battery backup unit at a network node other than a network node configured to receive backup power from the battery backup unit. This baseline information at the network node at which it is stored is subsequently updated with state or event information relating to the battery backup unit.

A further embodiment of the present invention generates revenue through the sale of information relating to a network device. State information of a network node is stored, including at least some state information that is accessible only through direct automated access to the network node. A fee is the collected for the state information.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example network in which example embodiments of the present invention may be employed.

FIG. 2 is a block diagram of an example Optical Network Terminal (ONT) equipped with a BBU, craft port, and technician interface.

FIG. 3 is a network diagram annotated with arrows illustrating example flows of BBU information through an example network.

FIG. 4 is a block diagram annotated with arrows illustrating example flows of information associated with a BBU and value (e.g., money) exchanged by various parties for the information or access to the information.

FIGS. 5A-5P are flow diagrams illustrating various methods for monitoring a BBU.

FIGS. 6A-6L are block diagrams illustrating various apparatuses for monitoring a BBU.

### DETAILED DESCRIPTION OF THE INVENTION

A description of example embodiments of the invention follows.

It would be useful for manufacturers of network nodes and battery backup units (BBUs) to consider scenarios that can improve the products such that manufacturers, customers and end users can easily manage them. Benefits may include, for example, battery lifetime expectancy, report keeping, or diagnostic tools that allow technicians to store data within the network device that are related to BBU batteries, such as installation date, battery type, etc. Further, it would be useful to have a utility that logs and notifies service providers and subscribers, if needed, of potentially hazardous conditions existing at a BBU or a BBU battery.

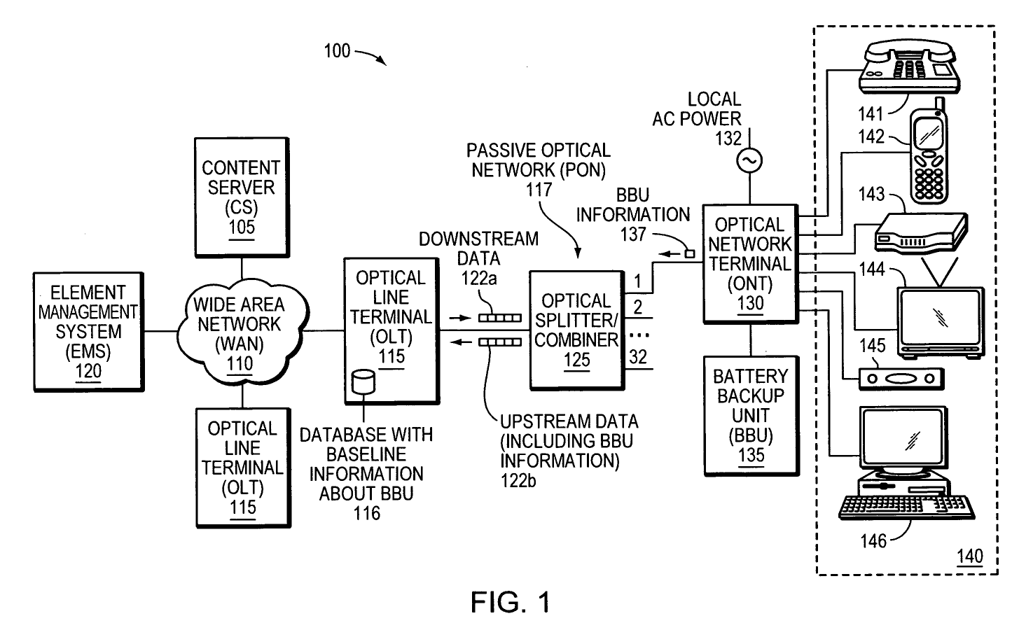

FIG. 1 is a block diagram of an example network 100 in which example embodiments of the present invention may be employed. The network 100 includes a Wide Area Network (WAN) 110 and a Passive Optical Network (PON) 117. The WAN 110 may be a network such as the Internet, and the PON 117 is typically a more localized network in which optical signals, used to transmit information, such as downstream data 122a and upstream data 122b, traverse passive optical elements, such as splitters and combiners 125, to be communicated between network nodes, such as an Optical Line Terminal (OLT) 115 and an Optical Network Terminal (ONT) 120.

The example network 100 of FIG. 1 includes one or more OLTs 115, an Element Management System (EMS) 120, and a Content Server (CS) 105, all connected, generally, by the WAN 110. In the example network 100, each OLT 115 transmits/receives information in the form of a frame of packets 122a, 122b embodied on optical signals to/from an optical splitter/combiner 125 to communicate with up to thirty-two ONTs 120. Each ONT 120 receives primary power by local alternating current (AC) power 122 at respective points of installation. The ONTs 120 provide connectivity to customer premises equipment 140 that may include standard telephones 141 (e.g., Public Switched Telephone Network (PSTN) and cellular network equipment), Internet Protocol (IP) telephones 142, network routers 142, video devices (e.g., televisions 144 and digital cable decoders 145), computer terminals 146, digital subscriber line connections, cable modems, wireless access devices, as well as any other conventional, newly developed, or later developed devices that may be supported by the ONT 120.

ONTs 120 may be equipped with batteries or BBUs 125, interchangeably referred to herein as BBUs 125. In an event an ONT 120 equipped with a BBU 125 experiences an interruption in primary power (e.g., local AC power 122), the ONT 120 may enable the BBU 125 or otherwise accept receipt of power from the BBU 125 to maintain services until the primary power source 122 is restored or the BBU 125 is drained of stored energy.

A memory, such as a database 116 maintained on the OLT 115, may store information 127 about the BBU 125 (“BBU information” 127). The BBU information 127 in the database 116 may be accessible by the OLT 115 and BBU 125, as well as other network elements of the PON 117, such as the EMS 120.

According to an example embodiment of the present invention, a method for monitoring a BBU, and a corresponding apparatus an electromagnetic signal carrying computer-readable instructions, stores baseline information about the BBU at a network node other than a network node configured to receive backup power from the BBU. The baseline information may be updated at the network node at which it is stored with state or event information relating to the BBU.

The baseline information may be stored at a time of installation of the BBU. The baseline information may be stored at a time after a time of installation of the BBU, wherein the baseline information further may be accepted by a manufacturer of or a service provider employing the BBU. The baseline information may be stored automatically, or may be manually entered.

The baseline information may be stored locally at an ONT or the BBU. It also may be transmitted to an OLT or a management system associated with the OLT. The baseline information may be transmitted via at least one optical communications path. The baseline information may be retrieved from a source, which may be an OLT or a management system associated with the OLT.

The state information used to update the baseline information includes temperature, voltage, current, availability, usage or age. Moreover, the event information used to update the baseline information includes alarm information, duration of alarms or frequency of alarms.

Information regarding the BBU may be fed back to a manufacturer of or a service provider or third party employing the BBU. A fee may be collected for the information. The information may be correlated with BBU information, including at least one of manufacturer, specifications, age and ONT/BBU combinations. An interested party may be informed of the correlation. Further, a BBU may be recommended to an interested party.

An interested party also may be informed of BBU compatibility, recall status, specifications, enhanced feature products, ordering information and performance history, optionally including alarms on an annual basis. Further, an interested party may be notified of a status for replacement of a battery or cell within the BBU.

The information may be forwarded to a regulatory body.

Revenue may be generated through sale of information relating to a network node by storing state information related to a network node including at least some state information accessible only through direct automated access to the network node and collecting a fee for the information. The state information may include information about a BBU.

The fee may be collected on a subscription service fee basis, or may be collected on a per-subnetwork basis, a per-BBU basis, a per-BBU manufacturer basis, or a per-BBU model number basis. The fee may be collected from a manufacturer of a battery configured to provide backup power to the network node, or from a service provider employing the BBU.

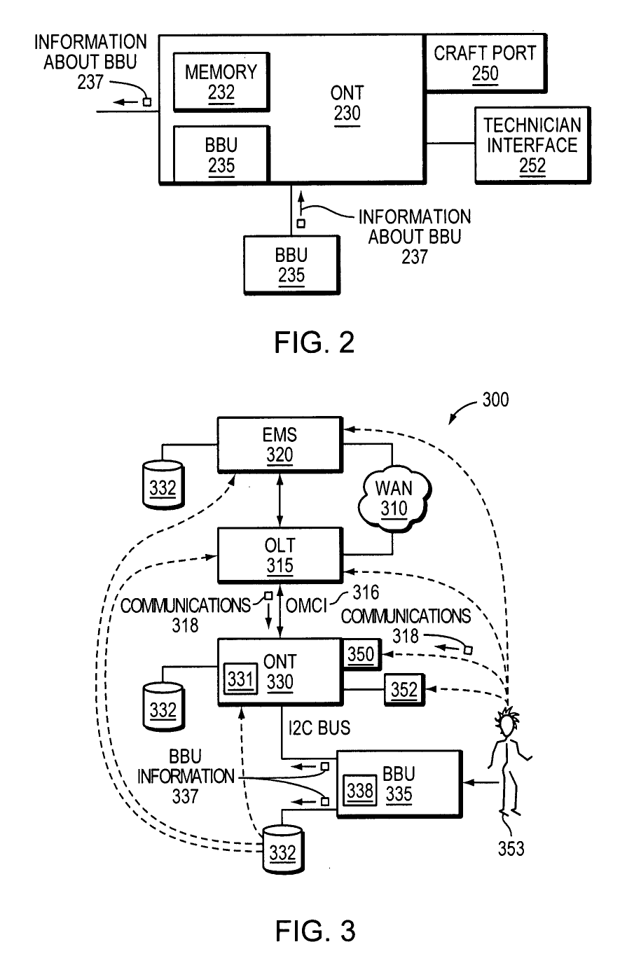

FIG. 2 is a block diagram of an example ONT 230 equipped with a BBU 235, craft port 250, and technician interface 252. In an example embodiment of the present invention, the ONT 230 logs and stores to a memory 232 information 237 of the BBU 235 (“BBU information” 237) via the craft port 250 or the technician interface 252. The technician interface 252 may be wired or wireless. The memory 232, which may be non-volatile flash memory or other form of memory, including volatile memory, may be local to the ONT 230 or local to the BBU 235, or may be remote storage at an OLT (115 of FIG. 1), EMS (120 of FIG. 1), or another data storage repository. The BBU 235 may be electrically connected to the ONT 230 in an internal or external manner, and an ONT 230 may employ multiple BBUs 235. The BBU information 237 may be communicated by direct internal communications from the BBU 235, itself, or the ONT 230 may monitor independently a power output or other signals available from the BBU 235 and record representations of the signal(s). Further, the ONT 230 may selectively choose the information it stores in memory to maximize the limited number of write cycles available in the case of flash memory or any other form of write cycle limited memory. Moreover, the memory may be a network-attached storage (NAS) device or other memory attached to the ONT.

FIG. 3 is a network diagram annotated with arrows illustrating example flows of BBU information 337 through an example network. In an example embodiment of the present invention, an ONT 330 receives communications 318 from a user 352 via a craft port 350 or technician interface 352, or from an OLT 315 via an ONT Management Communications Interface (OMCI) bus or channel on a shared bus 316, or other device on a network 310, such as an EMS 320. The communications 318 may include date information, battery manufacturing information, product data, installation dates, expiration date, life expectancy, etc. This data may then be stored in the ONT 330 in a memory 332.

Alternatively, the BBU 335 may, itself, provide the example information directly to the ONT 330 as described below, also in reference to FIG. 3. The ONT 330 may then periodically store BBU information 337 in the memory 332. Some BBUs 335 may be separately equipped with a battery 338. In some embodiments, once a battery 338 is installed in the BBU 335, the ONT 330 may accept parameters and may report, autonomously, on-demand, or on an event driven basis, any information from the memory 332 to the OLT 315 or EMS 320. This information may be stored when the ONT 330 detects replacement of the battery 338 within the BBU 335, or replacement of the BBU 335, itself, or when a technician issues BBU information 337 about battery log information through the craft port 350 or the technician interface 352. Further, the ONT 330 may store additional logging information about the battery 338, including historical battery events, such as low battery alarms, battery replacement alarms, and different battery voltage/amperage/power levels and power consumption, to provide additional information to service providers and battery manufacturers about the performance of their products in the field. The alarms provide additional troubleshooting information about the battery. A service provider can also use these alarms to determine the quality of the battery and determine if the battery is operating properly over time. Further, other external parameters that will impact the battery, includes the service interfaces (i.e., POTS, data, video, installation date, battery installation distance from ONT, etc.) that are enabled at any given time may be provided with battery data to establish causes of concern in the overall ONT-to-battery system.

An ONT 330 may also perform periodic, on-demand, or event-driven battery data storage. On-demand information may come from the OLT 315, or from a user 352 communicating locally with the ONT 320 via a craft port 350 or technician interface 352. Storage may also be triggered autonomously by the ONT 330 during specific conditions, such as major ONT alarm conditions, ONT hardware failure conditions, ONT-E-STOP-ON conditions, or any other operations defined in the International Telecommunications Union (ITC) Telecommunication Standardization Sector (ITU-T) Recommendation G.982.x and G.984.x.

Further, the ONT 330 may be configured to accept only specific batteries 338 from specific manufacturers. This configuration may be stored in software, firmware, or hardware. When a technician 352 or user goes into the field, such as to a user's home, to change the battery 338 or perform another maintenance related task, the technician 352 or user may log the update via the ONT's 330 craft port 350 or technician interface 352. Similarly, information may come from specific requests from the OLT 315 either ahead of time or from an on-site technician's handheld wireless provisioning device that is able to communicate with the OLT 315 to generate the appropriate provisioning information. During installation of a battery 338, if a technician 352 or subscriber enters invalid information regarding the battery 338, the ONT 330 may reject the data or, alternatively, generate an alarm or a specific visual indication to the service provider or technician 352 (or end user) to indicate that an invalid battery 338 has been installed. Further, the ONT may have a password associated with the battery that is sent from the EMS and configured via OMCI so that the ONT has either a specific password for a battery's serial number, model number or other identifier such that validation does not occur and a similar alarm or indication is provided.

In another example embodiment of the present invention, the ONT 330 communicates directly with the BBU 325 to collect information, such as static manufacturing data from an EPROM or similar memory 331, or other information, over a specialized data communications channel or protocol, such as an Inter Integrated Circuit (I2C) bus that provides real-time data. The ONT 330 may then take this real-time data and store it in the memory 332, as described above. This example embodiment may be implemented in addition to the technician-directed interface described above, or instead of it.

The OLT 315 and an EMS 320 may query (e.g., periodically) the battery log information from all ONTs 330 deployed in the field, and generate useful management reports therefrom. Information may be made available to an EMS 320 at any time, and may include any other status or performance monitoring data collected on the ONT 330. This data may be stored in a memory 332 within the ONT 330, such as non-volatile flash memory, so that it may be maintained across reboots and for long periods of time, in most cases for the lifetime of the battery 338, itself. For example, in cases where an ONT 330 is having field problems and the service provider returns the ONT 330 to its manufacturer, the stored information may be useful in diagnosing specific problems that may be due to battery 338 issues in the field. Collecting alarm data and associating it with specific battery characteristic will allow the service provider to understand the general behavior of the battery alarms when they are declared on a day-to-day basis and will further help the service provider to troubleshoot real-time problems in the field that may be associated with a given alarm/battery combination.

In a further example embodiment of the present invention, an OLT 315 may generate system-wide ONT 330 battery information reports that allow a service provider to notify subscribers to replace batteries 338 at a certain time before the expiration of the batteries 328. The OLT 315 or EMS 320 may periodically (or on an on-demand or event-driver basis) query the stored battery reports for each ONT 330 and, based on that information, generate reports that allow a service provider to notify its subscribers to replace batteries 328. Alternatively, the service provider may send a technician 352 to replace the batteries 338. The service provider may generate automated notifications to subscribers, such as emails, voice mails, written notification, or similar notifications, to let them know prior to and, certainly after, battery 328 expiration, that they need to replace the battery 338 in the BBU 335 of their ONT 330 as soon as possible.

In an example embodiment of the present invention, the BBU 335 may command the ONT 330 to provide limited or no services when the BBU 335 detects, at least, an invalid or expired battery 338. Similarly, the BBU 335 may direct the ONT 330 to enter a limited-service mode (e.g., emergency dial-out service, such as 9-1-1) when an invalid battery 338, or even no battery 338, is installed in the ONT 330. Further, the ONT 330 may have an option to provide full service but not utilize backup power supplied by an invalid battery 338 in a BBU 335 or may allow limited services when an invalid battery 338 is installed.

The ONT 330 may also be configured with a specific database of batteries 338 and associated expiration dates, a specific battery expiration date, or a generic battery life expectancy (e.g., 5 years) after battery installation in the BBU 335. Non-compliance with any of these conditions may trigger the ONT 330 to provide only limited, or no, subscriber service until the battery 338 is replaced. When such a situation occurs, alarms and reports may be logged in the memory 332, and reported as needed to the OLT 315, to ensure the right information is propagated in the network 300. The memory 332, such as non-volatile flash memory, may also provide invaluable information in cases where an invalid battery 338 causes an ONT 330 to fail.

For example, the ONT 330 may be aware that the expiration date of a battery 338 is January 1, three years from the year of installation. When the expiration date arrives, and the ONT 330 also detects that the battery 338 has not been replaced, the ONT 330 may be directed by the BBU 335 to enter a limited-service mode. Further, there may be various service levels based on the expiration date such that an initial notification or warning may be provided a certain time before the expiration date or a severe limitation or cancellation of services may be imposed at the passing of the expiration date. In one example mode, the ONT 320 may only provide lifeline plain old telephone service (POTS), such as 911 or e911 service, to the subscriber.

The expiration date of the battery 338 may be a safe amount of time before the battery 328 poses any serious threat or problems to the customer, and serves as a fail-safe mechanism that may minimize future problems, such as battery backup unit failure, faced by subscribers. This may also minimize possible litigation issues with the customer or hazardous/ecological problems at the point of installation.

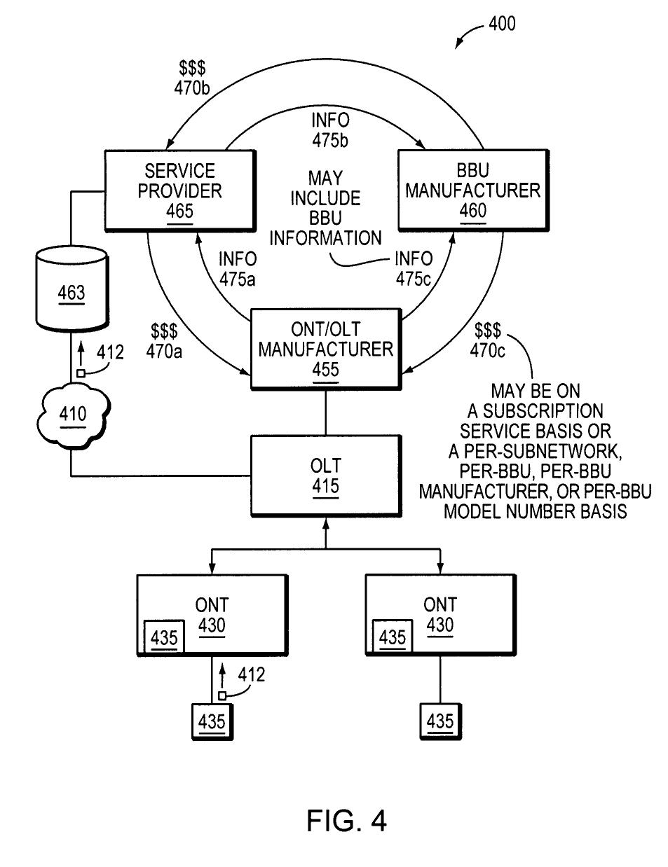

FIG. 4 is a block diagram annotated with arrows illustrating example flows of information associated with a BBU and value (e.g., money) exchanged by various parties for the information or access to the information. In this example embodiment of the present invention, an ONT/OLT manufacturer 455 may collect information 412 about BBUs 425 deployed in the field. The BBU 425 may be electrically connected internal to or external from the ONT 420, with up to thirty-two ONTs connected in a PON 400 to an OLT 415. The ONT/OLT manufacturer 455 may maintain the information 412 or, alternatively, may pass the data over a network 410 to store it in a repository 462. The ONT/OLT manufacturer 455 may then collect a fee 470a, 470c for the information 475a, 475c from other parties, such as a BBU manufacturer 460, a service provider 465, or a third party. This fee 470a, 470c may be collected on a subscription service fee basis, a per-subnetwork basis, a per-BBU 425 basis, a per-BBU manufacturer 460 basis, or a per-BBU 425 model number basis. The data stored in the repository 462 may be made available to a service provider 465 for a fee 470a. In this situation, the service provider 465 may then, as a “middle man,” sell the information 475b to the BBU manufacturer 460 or a third party for a fee 470b. Or, alternatively, the ONT/OLT manufacturer 455 may directly sell the information 475a, 475c to the BBU manufacturer 460, the service provider 465 or the third party for a fee 470a, 470c. The information also may be used by ONT manufacturers to determine if particular batteries are sufficiently compatible with the ONT and if the ONT manufacturer wants to continue endorsing support of a specific battery.

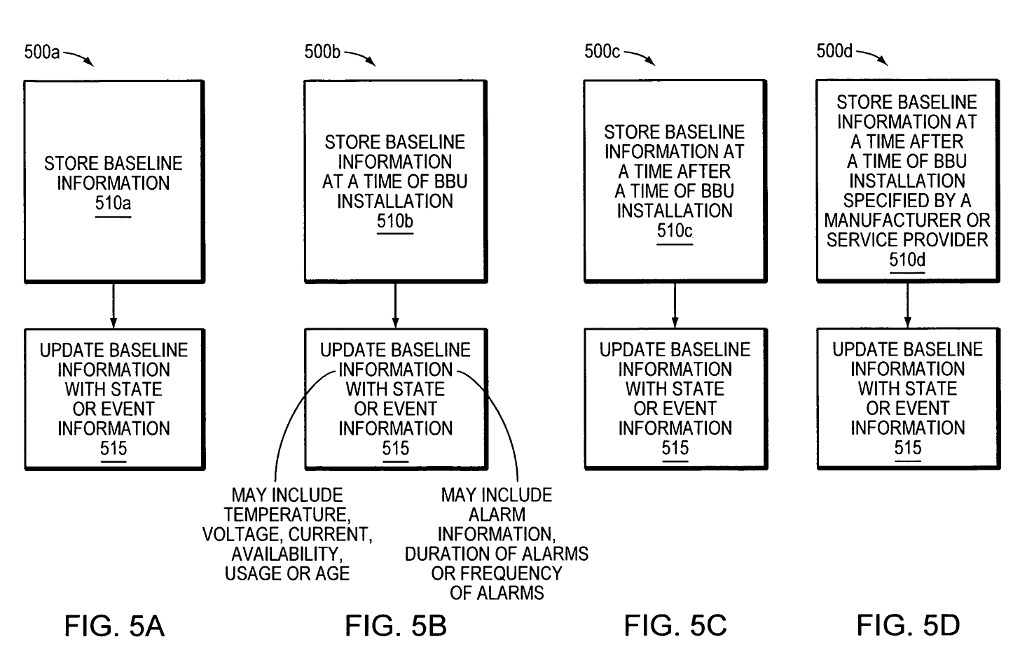

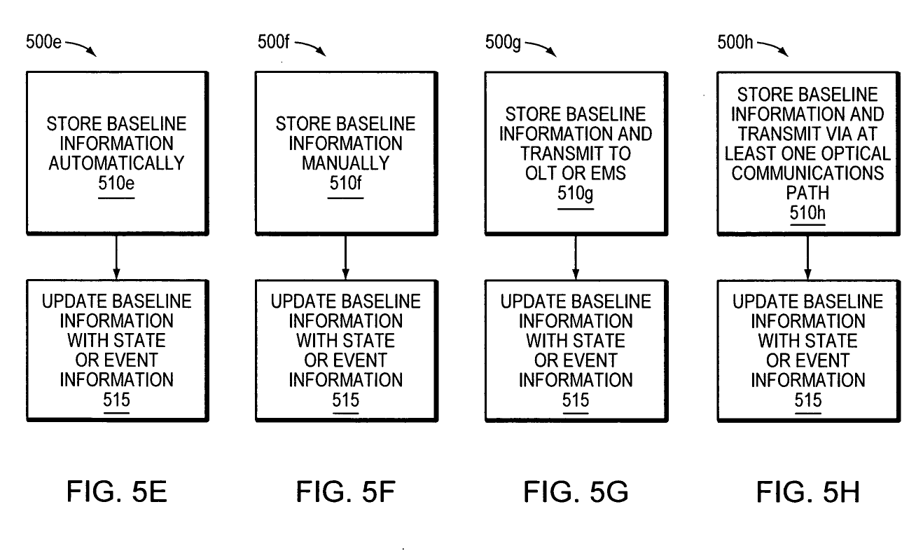

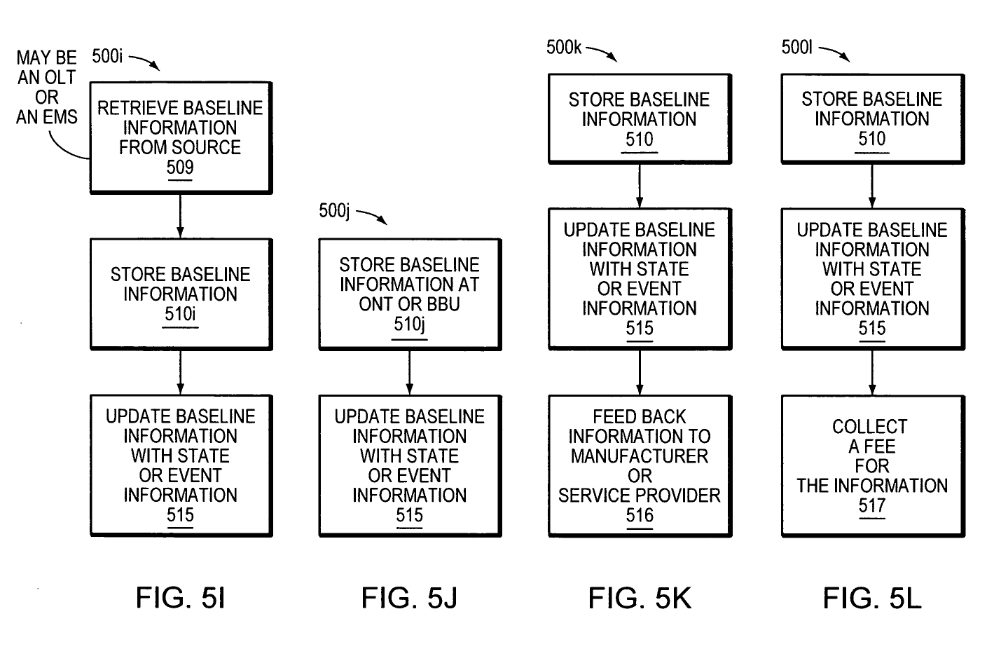

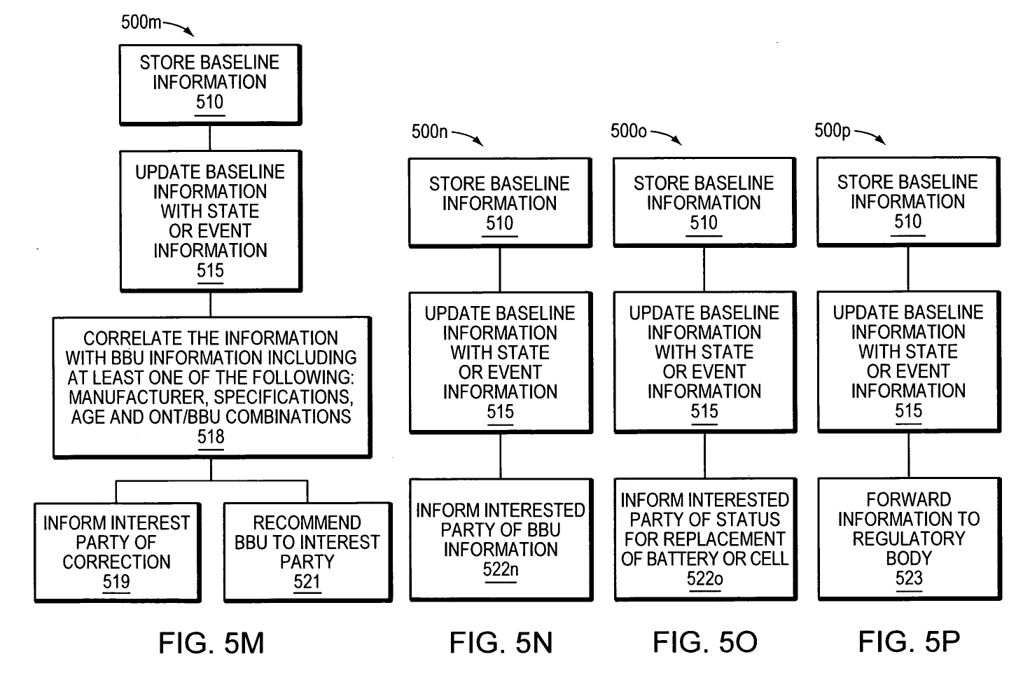

FIGS. 5A-5P are flow diagrams illustrating various methods of monitoring a BBU. FIG. 5A is a flow diagram 500a illustrating how baseline information about a BBU may be stored 510a at a network node other than a network node configured to receive backup power from the BBU. The baseline information may be updated 515 with state or event information. FIG. 5B is a flow diagram 500b illustrating how the baseline information may be stored 510b at a time of installation of the BBU. Further, the state information may include temperature, voltage, current, availability, usage or age. Moreover, the event information may include alarm information, duration of alarms or frequency of alarms. FIG. 5C is a flow diagram 500c illustrating how the baseline information may be stored 510c at a time after a time of installation of the BBU. FIG. 5D is a flow diagram 500d illustrating how the baseline information may be stored 510d at a time after a time of installation of the BBU and specified by a manufacturer of or service provider employing the BBU.

FIGS. 5E-5F are flow diagrams 500e, 500f illustrating how the baseline information may be stored automatically 510e or manually 510f, respectively. FIG. 5G is a flow diagram 500g illustrating how the baseline information may be stored and transmitted 510g to an OLT or EMS. The transmission, as illustrated in the flow diagram 500h of FIG. 5H, may be via at least one optical communications path 510h. FIG. 5I is a flow diagram 500l illustrating how the baseline information may be retrieved from a source 509, such as an OLT or an EMS.

Moreover, the information may be fed back 516 to a manufacturer of or service provider employing the BBU, as illustrated in the flow diagram 500k of FIG. 5K and, as illustrated in the flow diagram 500l of FIG. 5L, a fee may be collected 517 for the information.

As illustrated in the flow diagram 500m of FIG. 5M, the information may be correlated 518 with BBU information including at least one of the following: manufacturer, specifications, age and ONT/BBU combinations. An interested party may then be informed 519 of the correlation or a BBU may be recommended 521. Further. FIG. 5N is a flow diagram 500n illustrating how an interested party may be informed 522n of the BBU information, and, as in the flow diagram 500o of FIG. 5O, may be informed 522o of a status for replacement of a battery or cell within a BBU. FIG. 5P is a flow diagram 500p illustrating that the information may be forwarded 523 to a regulatory body.

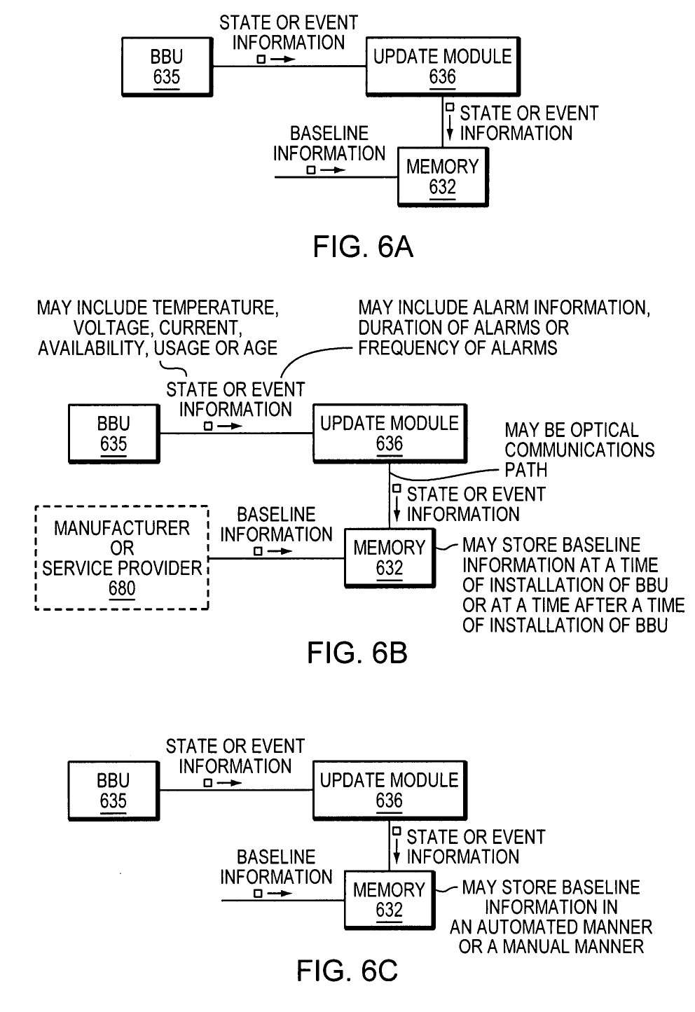

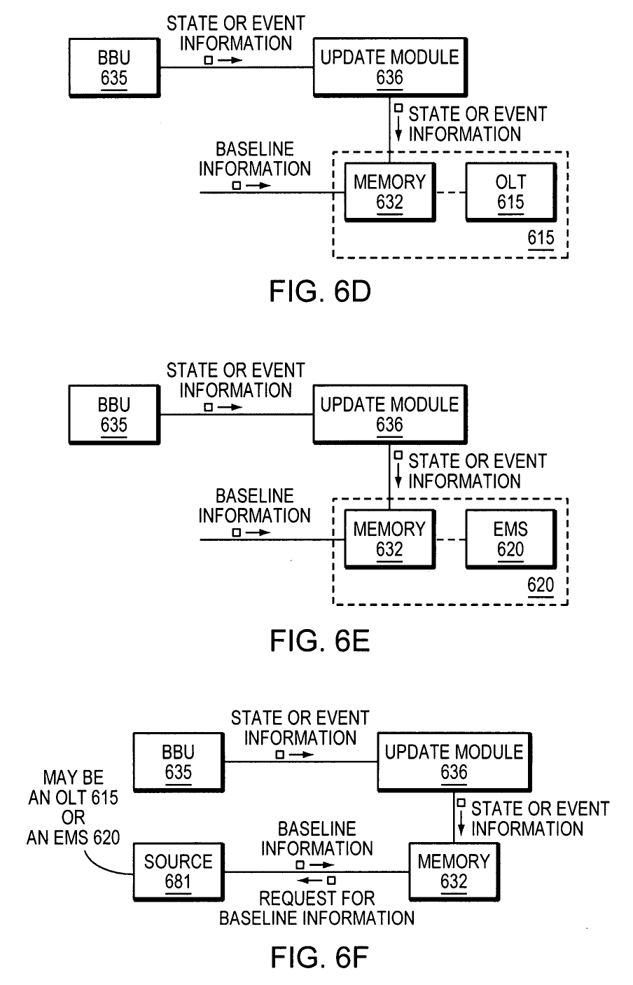

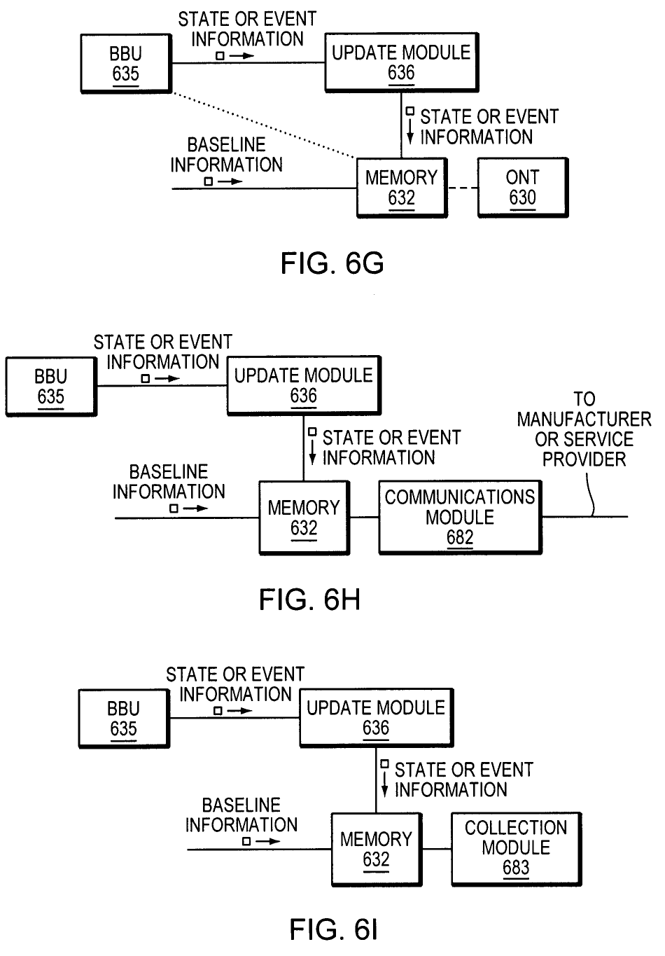

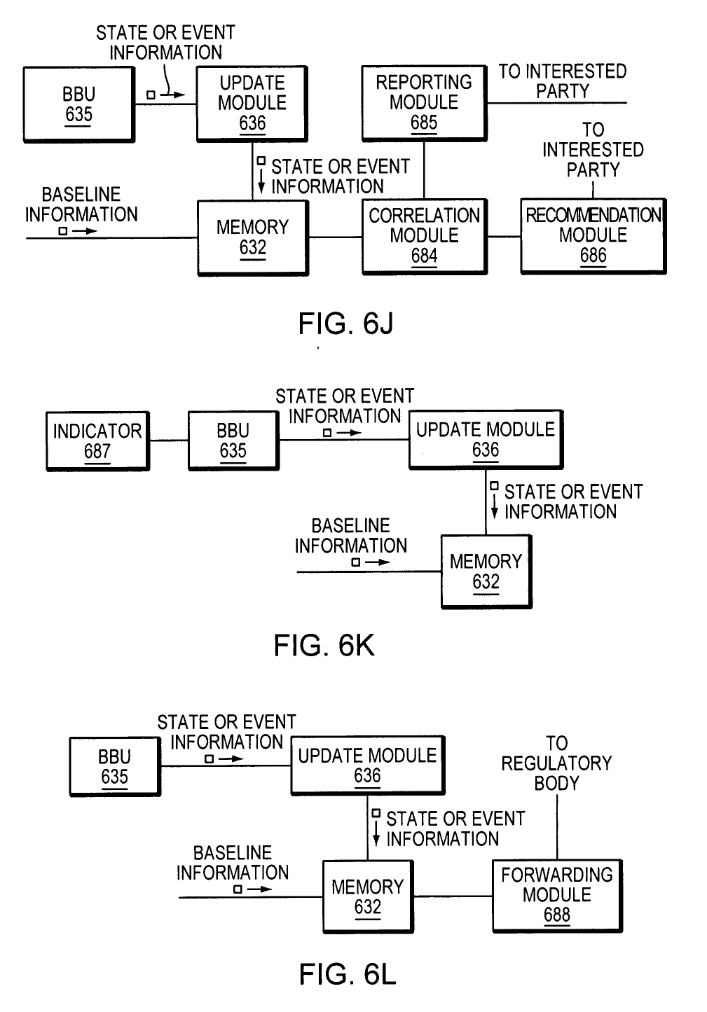

FIGS. 6A-6L are block diagrams illustrating various apparatuses for monitoring a BBU. As illustrated in FIG. 6A, such an apparatus may comprise a memory 632 at a network node configured to receive backup power from the BBU 635 configured to store baseline information about the BBU 635 and an update module 636 to update the baseline information in the memory 632 at the network node at which it is stored with state or event information relating to the BBU 635.

As illustrated in FIG. 6B, the baseline information may be stored at a time of installation of the BBU 635 or at a time after a time of installation of the BBU 635. The baseline information may be specified by a manufacturer of or service provider employing 680 the BBU. Further, the memory 632 and update module 636 may be separated by at least one optical communications path. Moreover, the state information may include temperature, voltage, current, availability, usage or age; the event information may include alarm information, duration of alarms or frequency of alarms.

FIG. 6C illustrates an example embodiment in which the memory 632 is configured to store the baseline information in an automated manner or a manual manner. As illustrated in FIGS. 6D-6E, the memory 632 may be in or coupled to an OLT 615 or an EMS 620, respectively. Further, as illustrated in FIG. 66F, the baseline information may be stored at a source 681, which may be an OLT 615 or EMS 620. The memory 632 may then retrieve the baseline information from the source 681. As illustrated in FIG. 6G, the memory 632 may be coupled to an ONT 630 or to the BBU 635.

The apparatus, as illustrated in FIG. 6H, may further comprise a communications module 682 coupled to the memory 632 to feed back information regarding the BBU 635 to a manufacturer of or a service provider employing the BBU 635. Moreover, as illustrated in FIG. 6I, the apparatus may comprise a collection module 683 configured to collect a fee for the information.

As illustrated in FIG. 6J, the apparatus may further comprise a correlation module 684 configured to correlate the information with BBU information, including at least one of: manufacturer, specifications, age and ONT/BBU combinations. Further, the apparatus may include a reporting module 685 configured to report the information correlated by the correlation module 684 to an interested party. Moreover, the apparatus may comprise a recommendation module 686 configured to recommend a BBU 635 to an interested party. A reporting module 685 may also report to an interest party battery backup unit compatibility, recall status, specifications, enhanced feature products, ordering information and performance history, optionally including alarms on an annual basis.

As illustrated in FIG. 6K, the apparatus may further comprise an indicator 687 to indicate a status for replacement of a battery or cell within the BBU 635. As illustrated in FIG. 6L, the apparatus may comprise a forwarding module 688 configured to forward the information to a regulatory body.

Further embodiments may include a cellular telephone that reports battery data through its network, a laptop computer with a special application that communicates with a server to provide up-to-date information, or any other device that may use AC power as a primary power source with a battery as a secondary power source, such as a personal digital assistance (PDA), cable modem, set-top box or router. A traditional consumer-grade uninterruptible power supply (UPS) may have an integrated microprocessor that is capable of monitoring battery functions and an Internet connection via Ethernet, Bluetooth or Wi-Fi over which that information may be communicated. Moreover, a car may report battery related information via a service that communicates car data.

While this invention has been particularly shown and described with references to example embodiments thereof, it will be understood by those skilled in the art that various changes in form and details may be made therein without departing from the scope of the invention encompassed by the appended claims.

What is claimed is:

1. A method for monitoring a battery backup unit, comprising:
storing baseline information about a battery backup unit at a network node other than a network node configured to receive backup power from the battery backup unit; and
updating the baseline information at the network node at which it is stored with state or event information relating to the battery backup unit.

2. The method of claim 1 wherein storing the baseline information further comprises storing the baseline information at a time of installation of the battery backup unit.

3. The method of claim 1 wherein storing the baseline information further comprises storing the baseline information at a time after a time of installation of the battery backup unit.

4. The method of claim 3 wherein storing the baseline information further comprises accepting specified baseline information by a manufacturer of or a service provider employing the battery backup unit.

5. The method of claim 1 wherein storing the baseline information further comprises automatically storing the baseline information.

6. The method of claim 1 wherein storing the baseline information further comprises manually entering the baseline information.

7. The method of claim 1 wherein storing the baseline information further comprises transmitting the baseline information to an Optical Line Terminal (OLT) or a management system associated with the OLT.

8. The method of claim 1 wherein storing the baseline information further comprises transmitting the baseline information via at least one optical communications path.

9. The method of claim 1 wherein storing the baseline information further comprises retrieving the baseline information from a source.

10. The method of claim 9 wherein the source is an Optical Line Terminal (OLT) or a management system associated with the OLT.

11. The method of claim 1 wherein storing the baseline information further comprises storing the baseline information locally at an Optical Network Terminal (ONT) or the battery backup unit.

12. The method of claim 1 wherein the state information includes temperature, voltage, current, availability, usage or age.

13. The method of claim 1 wherein the event information includes alarm information, duration of alarms or frequency of alarms.

14. The method of claim 1 further comprising:
feeding back information regarding the battery backup unit to a manufacturer of or a service provider or third party employing the battery backup unit.

15. The method of claim 1 further comprising:
collecting a fee for the information.

16. The method of claim 1 further comprising:
correlating the information with battery backup unit information, including at least one of the following:
manufacturer, specifications, age and Optical Network Terminal (ONT)/battery backup unit combinations.

17. The method of claim 16 further comprising:
informing an interested party of the correlation.

18. The method of claim 16 further comprising:
recommending a battery backup unit to an interested party.

19. The method of claim 1 further comprising:
informing an interested party of battery backup unit compatibility, recall status, specifications, enhanced feature products, ordering information and performance history, optionally including alarms on an annual basis.

20. The method of claim 1, further comprising:
notifying an interested party of status for replacement of a battery or cell within the battery backup unit.

21. The method of claim 1 further comprising:
forwarding the information to a regulatory body.

22. An apparatus for monitoring a battery backup unit, comprising:
memory at a network node other than a network node configured to receive backup power from the battery backup unit configured to store baseline information about the battery backup unit; and
an update module to update the baseline information in the memory at the network node at which it is stored with state or event information relating to the battery backup unit.

23. The apparatus of claim 22 wherein the memory is configured to store the baseline information at a time of installation of the battery backup unit.

24. The apparatus of claim 22 wherein the memory is configured to store the baseline information at a time after a time of installation of the battery backup unit.

25. The apparatus of claim 24 wherein the memory is configured to store the baseline information as specified by a manufacturer of or a service provider employing the battery backup unit.

26. The apparatus of claim 22 wherein the memory is configured to store the baseline information in an automated manner.

27. The apparatus of claim 22 wherein the memory is configured to store the baseline information in a manual manner.

28. The apparatus of claim 22 wherein the memory is in or coupled to an Optical Line Terminal (OLT) or a management system.

29. The apparatus of claim 22 wherein the memory and update module are separated by at least one optical communications path.

30. The apparatus of claim 22 wherein the memory is configured to retrieve the baseline information from a source.

31. The apparatus of claim 30 wherein the source is an Optical Line Terminal (OLT) or a management system associated with the OLT.

32. The apparatus of claim 22 wherein the memory is in or coupled to an Optical Network Terminal (ONT) or the battery backup unit.

32. The apparatus of claim 22 wherein the state information includes temperature, voltage, current, availability, usage or age.

34. The apparatus of claim 22 wherein the event information includes alarm information, duration of alarms or frequency of alarms.

35. The apparatus of claim 22 further comprising:
a communications module coupled to the memory to feed back information regarding the battery backup unit to a manufacturer of or a service provider employing the battery backup unit.

36. The apparatus of claim 22 further comprising:
a collection module configured to collect a fee for the information.

37. The apparatus of claim 22 further comprising:
a correlation module configured to correlate the information with battery backup information, including at least one of the following:
manufacturer, specifications, age and Optical Network Terminal ONT)/battery backup unit combinations.

38. The apparatus of claim 37 further comprising:
a reporting module configured report the correlated information to an interested party.

39. The apparatus of claim 37 further comprising:
a recommendation module configured to recommend a battery backup unit to an interested party.

40. The apparatus of claim 22 further comprising:
a reporting module configured to report to an interested party battery backup unit compatibility, recall status, specifications, enhanced feature products, ordering information and performance history, optionally including alarms on an annual basis.

41. The apparatus of claim 22 further comprising:
an indicator to indicate a status for replacement of a battery or cell within the battery backup unit.

42. The apparatus of claim 22 further comprising:
a forwarding module configured to forward the information to a regulatory body.

43. An electromagnetic signal carrying computer-readable instructions for monitoring a battery backup unit, the instructions comprising instructions which, when executed by a processor, cause the processor to:
store baseline information about a battery backup unit at a network node other than a network node configured to receive backup power from the battery backup unit; and
update the baseline information at the network node at which it is stored with state or event information relating to the battery backup unit.

44. A method of generating revenue through sale of information relating to a network device, comprising:
storing state information related to a network node including at least some state information accessible only through direct automated access to the network node; and
collecting a fee for the information.

45. The method of claim 44 wherein the state information includes information about a battery backup unit.

46. The method of claim 44 wherein collecting the fee for the information includes collecting the fee on a subscription service fee basis.

47. The method of claim 44 wherein collecting the fee for the information includes collecting the fee on a per-subnetwork basis.

48. The method of claim 44 wherein collecting the fee for the information includes collecting the fee on a per-battery backup unit basis.

49. The method of claim 44 wherein collecting the fee for the information includes collecting the fee on a per-battery backup unit manufacturer basis.

50. The method of claim 44 wherein collecting the fee for the information includes collecting the fee on a per-battery backup model number basis.

51. The method of claim 44 wherein collecting the fee for the information includes collecting the fee from a manufacturer of a battery or battery backup unit configured to provide backup power to the network node.

52. The method of claim 44 wherein collecting the fee for the information includes collecting the fee from a service provider employing the battery backup unit.
